(19) United States
(12) Patent Application Publication
(10) Pub. No.: US 2015/0246576 A1
(43) Pub. Date: Sep. 3, 2015

(54) AUTOMOTIVE WHEEL OVERLAY ATTACHMENT SYSTEM

(71) Applicant: Keystone Automotive Industries, Inc., Chicago, IL (US)

(72) Inventor: Mitchell Nunes, Brandon, FL (US)

(21) Appl. No.: 14/559,184

(22) Filed: Dec. 3, 2014

Related U.S. Application Data
(60) Provisional application No. 61/946,451, filed on Feb. 28, 2014.

(51) Int. Cl. B60B 7/06; B60B 7/18; B60B 7/00

(52) U.S. Cl. CPC B60B 7/068; B60B 7/0066; B60B 7/0033; B60B 7/18; B60B 2900/50

(57) ABSTRACT

A vehicle wheel overlay is disclosed in which one or more extensions of the vehicle wheel overlay engages one or more lug nuts affixing a wheel to a vehicle body to securely attach the vehicle wheel overlay to the vehicle wheel/body. In an embodiment, the disclosed vehicle wheel overlay includes extensions that each includes a lip to engage a ridge or other structural feature of the lug nuts of the vehicle. In various embodiments, the lips are shaped to enable the vehicle wheel overlay to be readily installed and/or removed simply by pushing or pulling on the vehicle wheel overlay with respect to the vehicle wheel. In various embodiments, one or more additional attachment mechanisms attach the overly directly to the wheel in addition to engaging the lug nuts.

### PRIORITY CLAIM

This application claims priority to and the benefit of U.S. Provisional Patent Application No. 61/946,451, filed Feb. 28, 2014, which is incorporated herein by reference in its entirety.

### DESCRIPTION

The present disclosure relates to wheel overlays for automotive and other vehicle wheels, and more specifically to improvements to known overlays for automotive and other vehicle wheels in which one or more extensions, which may include one or more lips, of a wheel overlay engage one or more lug nuts or other wheel fastening mechanisms of the vehicle wheel to affix the wheel overlay to the vehicle wheel.

### BACKGROUND

Known wheel overlays are deficient in that they do not provide efficient or effective fastening to the underlying wheel of an automobile or other vehicle. Specifically, known wheel overlays do not provide fastening mechanisms that are easily attachable, do not provide fastening mechanisms that are easily removable, and do not rely on aesthetically pleasing clips or fastening members. What is needed is a wheel overlay system that satisfies these and other deficiencies of known automotive or other vehicle wheel overlay systems.

Simulated chrome plated wheel covers designed to be installed over standard factory wheels are known. For example, U.S. Pat. No. 6,010,196, U.S. Pat. No. 6,402,253, U.S. Pat. No. 6,409,277, and U.S. Pat. No. 6,672,678 disclose embodiments of simulated chrome plated wheel covers or overlays that rely on fasteners arranged around the outside of the wheel to affix the cover to the wheel. In some of these embodiments, the described fasteners rely on an upward extending circumferential edge on the vehicle wheel to which the fasteners can be removably affixed. Typically the wheels to which such overlays are affixed are made of steel. In these embodiments, the wheel covers would either completely cover the lug nuts, or they would have openings corresponding to the positions of the lug nuts to enable access to the lug nuts (e.g., to allow the wheel to be removed) without taking the cover off. In these embodiments, if the wheel to which the overlay is going to be affixed lacks an upward extending circumferential edge, the known cover attachment mechanisms cannot be used. These known fasteners are also not aesthetically pleasing, as they are visible on the outer rim of the wheel cover and thus disrupt the aesthetic appearance of the wheel/overlay combination.

Aluminum alloy wheels presented a different challenge for simulated wheel covers because the wheels often use spokes and do not typically have a recessed outer rim. U.S. Pat. No. 7,452,037 shows a wheel cover that can be attached to an alloy wheel by duplicating the shape of the original wheel on the interior and acting as a skin. Fasteners are generally not used to affix wheel covers to alloy wheels; instead, the sides of the spokes of the wheel cover have a slight gap or offset. This gap is only the width of a slot or slots provided in each spoke. When the wheel cover is placed over the wheel, a mating mushroom head stud is typically aligned with one edge of the slot and is easily inserted onto an area of the slot slightly larger than the diameter of the stud. The wheel cover is then rotated clockwise until the stud snaps into place in a smaller area of the slot, thereby changing the gap from one side of the spoke to the other. These covers may either cover the hub completely or match the contour of the hub, thereby permitting the lug nuts to be exposed for easy removal of the wheel.

Creating wheel overlays that appear to be part of the wheel when mounted to the wheel presents a challenge. In particular, it is desirable to hide or obscure the fact that there is a wheel cover at all. In addition, it is desirable to have the wheel cover appear to be a solid wheel and not just a wheel cover. Moreover, it is desirable to not attach the wheel cover with fasteners, or by using mating mushroom heads. The instant disclosure satisfies these and other problems not previously solved in the prior art.

### SUMMARY

Various embodiments of the vehicle wheel overlay system disclosed herein provide for wheel overlays that are readily installable over existing wheels by attaching directly to lug nuts, studs, or other mounting hardware used to affix the wheel itself to the body of the vehicle. In addition, in some embodiments, the disclosed system provides for a wheel overlay that can be readily removed by disengaging lips of the extension(s) of the wheel overlay from the lug nuts holding the wheel to the vehicle, thus providing easy access to the lug nuts and enabling the wheel to be easily removed from the vehicle. Additionally, the wheel overlay disclosed herein can have an aesthetically pleasing finish, such as a chrome plated finish or a painted finish of a different color, to add to the aesthetic appearance of the vehicle. In some embodiments, the disclosed wheel overlays are unfinished, or in a raw form, so that the consumer or an aftermarket paint specialist can paint the overlays any color or pattern desired.

The instant disclosure also advantageously provides for wheel overlays that can be used on both steel and alloy wheels since both types of wheels can be (and typically are) attached by tightening lug nuts onto studs or lugs of the vehicle. Moreover, since the lug nut design in some embodiments does not depend on whether steel or alloy wheels are being affixed to a vehicle, the fastening mechanism for wheel overlays can be the same regardless of the material from which the wheel is constructed. In one embodiment, the disclosed vehicle wheel overlay includes a fastening structure corresponding to each lug nut that attaches to a corresponding lug nut. This structure can include one or more extensions that partially or fully encircle and engage a ridge of the lug nut. Each extension includes a lip at the end farthest from the overlay, which lip is configured to engage a portion of the lug nut, such that when the lips of each extension for a particular lug nut engage the lug nut, the overlay is affixed to the vehicle wheel. It is therefore an advantage of the present disclosure to provide these extensions to encircle and engage one or more of the lug nuts, thus securely attaching the vehicle wheel overlay.

The overlays disclosed herein can also mirror the shape and appearance of an underlying wheel, thus providing the appearance that no wheel overlay is being used. In one embodiment, the vehicle wheel overlay can mirror the shape of a five-spoke wheel with five lug nuts affixing the wheel to the body of the vehicle. In this embodiment, the vehicle wheel overlay includes one or more affixing elements corresponding to each lug nut. These elements can each include a plurality of extensions that together encircle a single lug nut. Each extension includes one or more lips at the end farthest from the overlay, which are configured to engage a portion of the lug nut, such as a ridge of the lug nut, thereby affixing the overlay to the vehicle wheel.

Various embodiments of the disclosed vehicle wheel overlay can have any shape appropriate to engage and mate with any underlying wheel. In these embodiments, the wheel overlay is configured to include any number of extensions for each lug nut, depending on the size, shape, and number of lug nuts and/or the desired permanence of affixing the overlay to the wheel. Extensions can be made of a deformable material that enables deflection such that the lips can engage and disengage from the lug nut by a user pressing or pulling the overlay toward or away from the lug nuts.

Additional features and advantages are described herein, and will be apparent from the following Detailed Description and the figures.

### BRIEF DESCRIPTION OF THE DRAWINGS

FIG. 1 is a front view of one embodiment of a wheel overlay.

FIG. 2 is a view of the back of the wheel overlay of FIG. 1, showing one embodiment of extensions of the present disclosure.

FIG. 3 is an enlarged view of the wheel overlay and extensions of FIG. 2.

FIG. 4 is an enlarged view of one of the extensions of FIG. 2 with a lug nut engaged by the lips of the extension.

FIG. 5 an enlarged view of one of the extensions of FIG. 2 with a lug nut and bolt engaged by the lips of the extension.

### DETAILED DESCRIPTION

In general, the vehicle wheel overlays disclosed herein affix to a vehicle wheel by using extensions that encircle and engage each lug nut. One or more of the extensions includes one or more lips at the end farthest from the overlay, which are configured to engage a portion of the lug nut, thereby affixing the overlay to the vehicle wheel. The wheel overlays can mirror the shape and appearance of an underlying wheel, while altering its outwardly visible finish, such that an installed vehicle wheel overlay provides the appearance that no overlay is present at all.

In various embodiments, the vehicle wheel overlay can be shaped to engage and mate with any underlying wheel. The wheel overlay can be configured to include any number of extensions to perform such engagement. The size, shape, and number of lug nuts can be used to choose the configuration and shape of the extensions. In various embodiments herein, the instant disclosure uses the word “stud” to refer to the threaded extension of a vehicle wheel onto which a wheel is mounted and onto which lug nuts are threaded. It should be appreciated that this same structure may in some settings be referred to as a “lug” onto which lug nuts are threaded.

In various embodiments, the lips of the extensions disclosed herein are rounded, such that an inclined edge engages the lug nut when the overlay is being installed and a different inclined edge engages the lug nut in an installed position and during removal. In various other embodiments, the lip is not rounded, but is angled or wedge-shaped. In some embodiments, the disclosed overlay includes one or more additional mechanisms for affixing to the wheel, including one or more adhesive strips, magnets, screws, rivets, bolts, or clips engaging a different part of the wheel (other than the lug nuts) to further secure the overlay to the wheel.

In various embodiments, the wheel overlay disclosed herein is formed of plastic, polycarbonate, metal, acrylic, or any other suitable material depending on the aesthetic and durability requirements of the overlay. As described below, the vehicle wheel overlays disclosed herein can be formed of different materials, such as by using a first material for the extensions and a second, different material for the remainder of the body of the vehicle wheel overlay.

More particularly, in various embodiments, the wheel overlay disclosed herein has a finish other than chrome plated or is a painted a different color. In some embodiments, the wheel overlay can be unfinished, or in the raw form, so that the consumer can paint the overlay to be any color or pattern he wants.

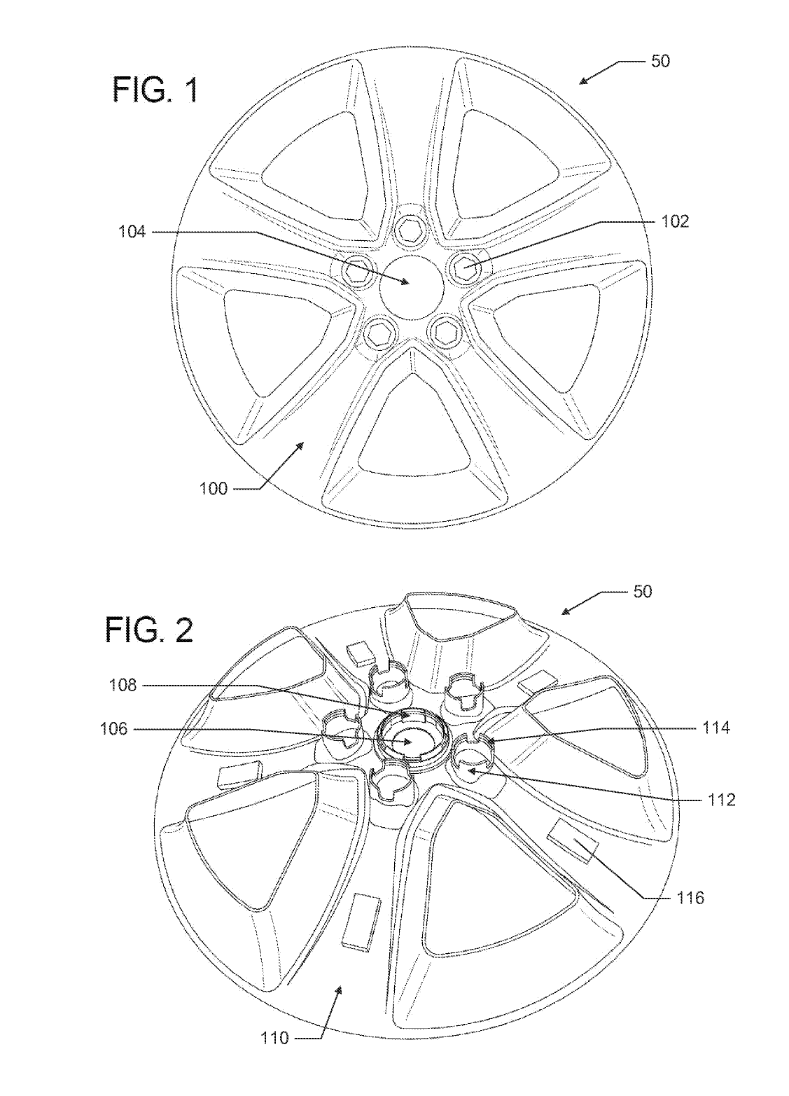

Referring now to the drawings and in particular to FIG. 1, an example of one embodiment of the vehicle wheel overlay 50 is shown. The vehicle wheel overlay 50 has a front face 100 with lug nuts 102 illustrated as extending through the front face 100. Lug nuts 102 can all be shaped the same, or they can be a variety of shapes, with some being similar or the same, and some being different.

Referring still to the front face 100, FIG. 1 illustrates a middle section 104 that can either be open to show and/or provide access to the wheel, or can have a solid section to cover up the wheel completely. The middle section 104 could have a logo affixed to the front face 100. In various embodiments, the middle section 104 of the front face 100 is an opening, and a correspondingly shaped center cap is configured to be mounted in the opening after installation of the disclosed vehicle wheel overlay. The center cap could be new center cap or it could be the original equipment manufacturer center cap. In other embodiments, the wheel overlay 50 is designed such that middle section 104 remains open even when installed on a vehicle wheel, enabling the logo on the center of the vehicle wheel to be visible through opening 104.

FIG. 2 illustrates a back view of one embodiment of the vehicle wheel overlay 50 disclosed herein. As can be seen from FIG. 2, the vehicle wheel overlay 50 has a back face 110. The back face 110 includes extensions 112 that have lips 114 at the end farthest from the back face 110. The extensions 112 can be permanently attached to the back face 110 or the extensions 112 can be removable, such as by being part of a threaded extension assembly that can thread into the body of the overlay 50. This embodiment permits the extensions to be replaced if, for example, they break or are deformed to the point of inadequately affixing the overlay to the vehicle wheel.

In various embodiments, such as that illustrated in FIG. 2, the back face 110 can also have adhesive or foam strips 116 that engage other parts of the wheel. The adhesive or foam strips 116 serve multiple purposes, such as to absorb any vibration between the wheel and wheel overlay, and can serve as a cushioning apparatus for installation purposes. Alternatively, the adhesive or foam strips 116 can be replaced with magnets, screws, rivets, bolts, or clips, to further assist in the engagement of the vehicle wheel overlay to the vehicle wheel. In other embodiments, no adhesive or foam strips 116 or other affixing structures are needed beyond the extensions 112.

Referring still to the back face 110 of the wheel overlay 50 of FIG. 2, the back of the middle section 106 is shown. The disclosed vehicle wheel overlay can include lips 108 disposed around the edge of the middle section 106, which lips 108 engage a center portion of the vehicle wheel. Alternatively, the lips 108 of the middle section 106 can engage a center cap or other insert (not shown) that can be installed and removed to provide access to the wheel. Such center cap may in various embodiments include a logo, such as a logo of an automobile or wheel manufacturer.

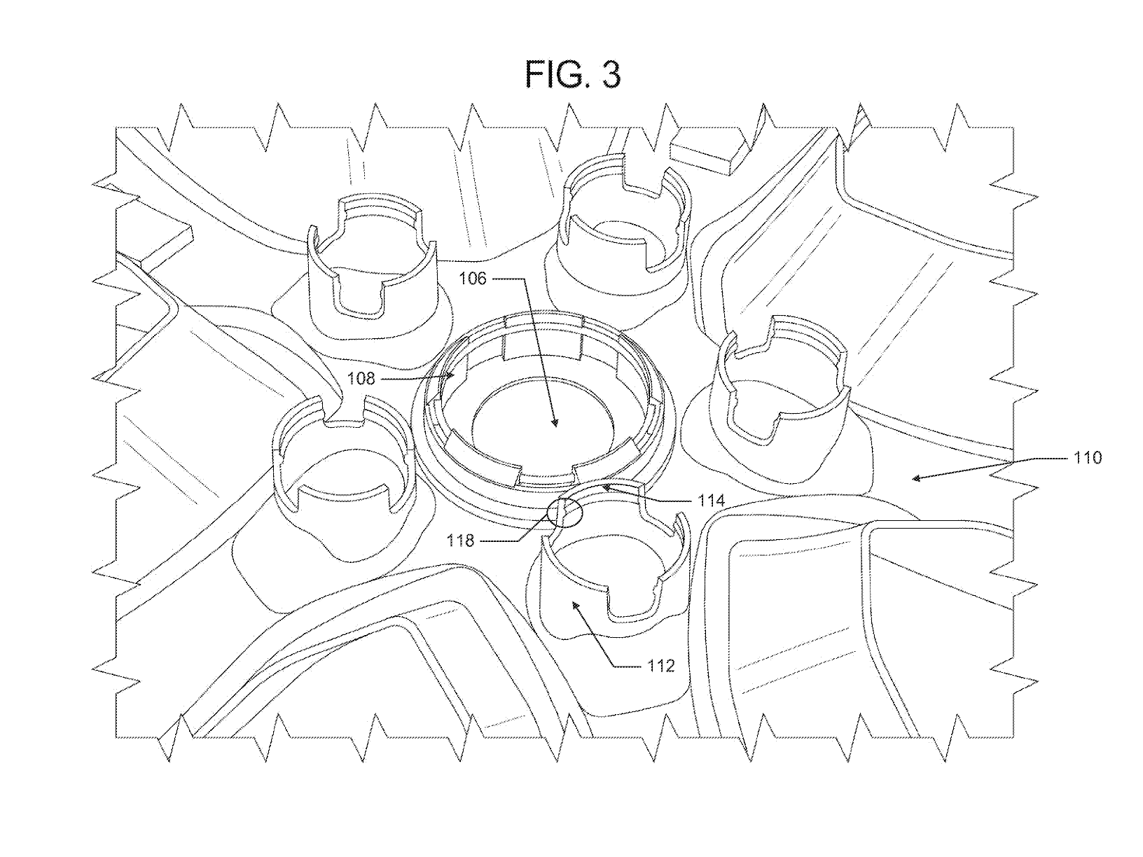

FIG. 3 illustrates an exploded view of an example of the back face 110. It shows the extensions 112 in more detail, along with the lips 114. The lips 114 can rounded as illustrated by cross section 118, or the lips 114 can be angled or wedge-shaped as appropriate to engage different shaped lug nuts. For example, a wedge-shaped lip may be used if more permanence is desired, as the inclined portion of the wedge-shaped lip engages the lug nut during installation to enable easy installation, but a perpendicular portion of the wedge-shaped lip may engage the lug nut after installation and thus during removal. This configuration, in which no incline engages the lug nut in the direction of motion of the wheel overlay during removal, means that the extensions do not deflect outwardly during removal and therefore prevent or restrict removal.

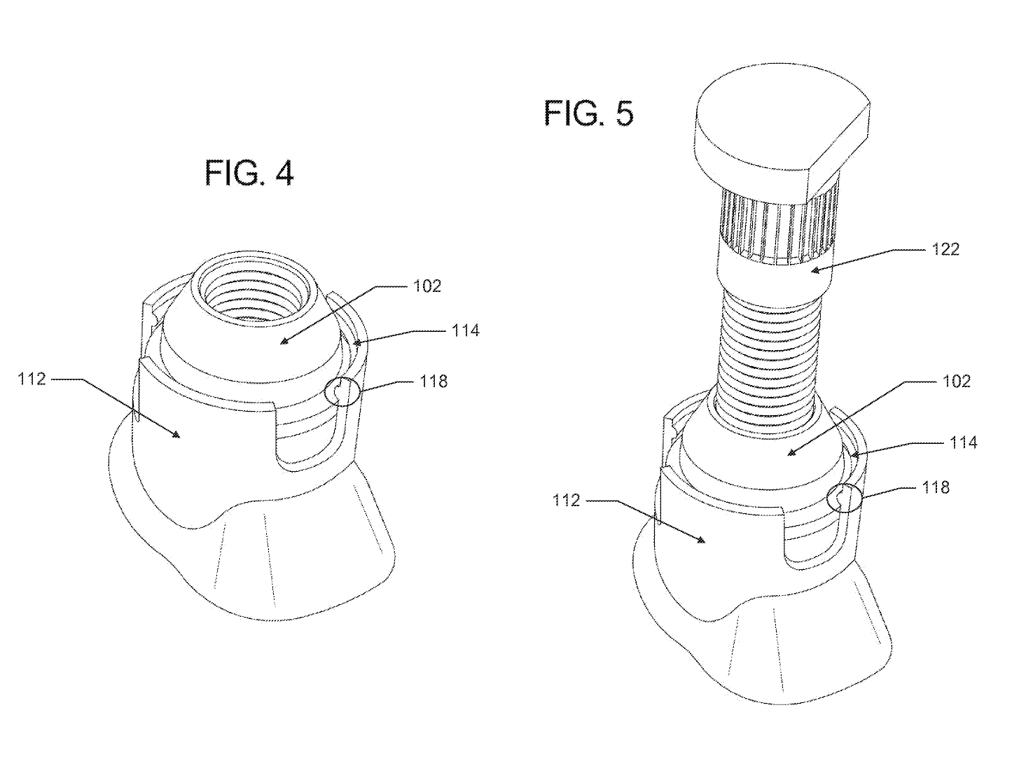

FIG. 4 illustrates an exploded view of an example of the lug nut 102 engaged with extension 112 and lips 114. The lips 114 are rounded as emphasized by cross section 118.

FIG. 5 illustrates an exploded view of an example of the lug nut 102 screwed onto or otherwise engaging stud 122. Lug nut 102 is engaged with extension 112 and lips 114.

It should be appreciated that FIGS. 4 and 5 each illustrate an example of the disclosed vehicle wheel overlay in an engaged or installed position, in that the lips 114 of the extensions 112 engage the lug nut 102 of the illustrated embodiment.

In the illustrated embodiments of FIGS. 1 to 5, the disclosed vehicle wheel overlay 50 includes three extensions 112 for each lug nut, each extension 112 having a corresponding lip portion 114 to engage lug nut 102. In other embodiments, the number of extensions can vary depending, for example, on the size and shape of the lug nut and/or the desired permanence of affixing for the disclosed overlay.

In an alternative embodiment of the vehicle wheel overlay disclosed herein, the lug nut can be configured to hook onto or interlock with the lips of the extensions. For example, in this embodiment, the extensions of the disclosed overlay may include one or more upturned (i.e., outward with respect to the vehicle wheel) concave lips that engage with a correspondingly shaped downturned (i.e., inward with respect to the vehicle wheel) concave lip of a specially designed lug nut. In such embodiments, it should be appreciated that the engagement of the vehicle wheel overlay with the lug nut is not easily broken, as an upward pull on the vehicle wheel overlay causes the concave portions of the extensions to engage the concave portions of the lug nut more tightly. Such an embodiment may therefore be used when additional security is desired, as installation is relatively easy but removal requires removal of the lug nuts themselves.

In one embodiment of the vehicle wheel overlay disclosed herein, the lug nuts must be removed prior to installing the wheel overlay, in order to better secure the overlay. For example, the extensions could have an additional lip that is located closest to the wheel so that when the lug nut is reattached, the overlay cannot be pulled upward without removing the lug nuts.

In one embodiment of the vehicle wheel overlay disclosed herein, the extensions are made out of the same material as the overlay, which could be plastic, polycarbonate, metal, acrylic, or any other suitable material depending on the aesthetic and durability requirements of the overlay. In an alternative embodiment of the vehicle wheel overlay, the extensions are made out of a different material than the overlay. For example, the extensions in various embodiments may be made of stronger, more resilient material (such as metal or alloy) to allow for repeated installation and removal without weakening of the extensions. As noted above, in various embodiments the extensions are provided as assemblies of extensions that can be removed from the vehicle wheel overlay and replaced as desired.

In an alternative embodiment of the vehicle wheel overlay, the extensions can be added or removed to allow for different configurations and numbers of lug nuts. For example, in an embodiment where extensions are provided as assemblies of extensions that can be threaded into the back of a vehicle wheel overlay, a greater number of threaded receiving areas may provided than the number of lug nuts for any particular vehicle. In this embodiment, the user may select the appropriate number and configuration of lug nuts onto which the overlay will be installed, and may thread extension assemblies into only those receiving areas matching that selected lug nut configuration.

In an alternative embodiment of the vehicle wheel overlay, the extensions can be customized for the type of lug nut being used. For example, depending on the configuration of a ridge of a lug nut, different shaped lips may be more readily installed and/or removed on such lug nuts. In these embodiments, removable extension assemblies allow for the user to select the lip configuration most appropriate for the lug nuts of the vehicle. In another embodiment, the selection of different lip configurations allows the user to select a desired amount of permanence. For example, selecting rounded lips such as those illustrated in FIGS. 1-5 may provide a relatively un-secure affixing because the overlay can be readily removed, while selection of a wedge-shaped or interlocking shape of lips may provide for more secure affixing.

In an alternative embodiment of the vehicle wheel overlay, the lug nuts are exposed and can be rotated, either to tighten or loosen, even when the overlay is attached. In these embodiments, the extensions engage a portion of the lug nut nearer to the vehicle wheel than a portion of the lug nut that engages a lug nut wrench used to loosen the lug nuts. In this embodiment, it should be appreciated that once the lug nut has been removed from the stud, the extensions/lips of the vehicle overlay no longer engage the lug nut, and thus removal of all the lug nuts achieves removal of the overlay from the wheel. In embodiments where removal of the overlay is not permitted by the shape of the lips of the extensions of the overlay do not permit removal of the overlay simply by pulling the overlay, removal can nonetheless be achieved by removing the lug nuts to which the overlay is attached.

In a presently preferred embodiment, the overlay disclosed has the same shape as the wheel and merely alters a perceived finish of the wheel. The altered finish can be something other than chrome plated, or it can be painted a color, or it can be unfinished. In alternative embodiments, the overlay has a different shape than the wheel, such as by adding one or more features (e.g., spinners, logos, spokes, etc.) not present on the underlying wheel.

In one embodiment, the system disclosed herein includes a removable center cap that, when installed partially or fully covers one or more of the lug nuts. The center cap uses the same type of extensions that the overlay uses to attach to the lug nuts. The lips of the extensions engage the lug nuts, thus affixing the center cap. In this embodiment, installation of the removable center cap therefore impedes access to the lug nuts, making removal of the overlay more difficult. In a further embodiment, the center cap or insert includes one or more keyed mechanisms to prevent removal of the center cap without an appropriate key.

In an alternative embodiment, the system disclosed herein includes a removable center cap that, when installed, permits one or more of the lug nuts and/or studs to extend through holes in an outer flange on the center cap. In this embodiment, the lug nuts tighten down on the stud, leaving the end of the stud exposed. Further, in this embodiment, a threaded lug nut cover is screwed onto the end of the stud, external to the lug nut and the center cap, to affix the center cap to the wheel. The threaded lug nut cover also acts as an additional mechanism for affixing the wheel overlay to the wheel and give additional support to the center of the overlay. Alternatively, the lug nuts used can have threading on the top-side that can be used to attach an extension to the studs. This allows for the threaded lug nut covers to be used to securely affix the center cap even when the studs are not long enough.

In another embodiment, the wheel overlay does not have extensions to affix the overlay and the center cap is the sole attachment mechanism. There, one or more of the lug nuts extend through an outer flange on the center cap. The lug nuts tighten down on the stud, leaving the end of the stud extending upward. Then the threaded lug nut covers screw onto the end of the studs to securely affix the center cap and the wheel overlay.

The above description is exemplary of the features of the system disclosed herein. It should be understood that various changes and modifications to the presently disclosed embodiments will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A vehicle wheel overlay shaped to engage with a vehicle wheel, the vehicle wheel including a plurality of recesses into which a lug nut is inserted, the vehicle wheel overlay comprising:
a body having a shape corresponding to a shape of the vehicle wheel and an aesthetically pleasing finish; and
a plurality of lug nut engaging areas, each lug nut engaging area including at least one extension configured to engage a portion of a lug nut after the lug nut has been tightened.

2. The vehicle wheel overlay of claim 1, wherein each extension includes at least one lip for engaging with and disengaging from a corresponding lug nut.

3. The vehicle wheel overlay of claim 2, wherein the shapes of each of the lips of each extension are based on the corresponding lug nut.

4. The vehicle wheel overlay of claim 2, wherein the shapes of each of the lips of each extension are one selected from the group consisting of: rounded, angled and wedge-shaped.

5. The vehicle wheel overlay of claim 3, wherein at least one extension is removable from the body.

6. The vehicle wheel overlay of claim 2, wherein the body includes a center portion having an opening, and wherein a center cap is insertable into the center portion.

7. The vehicle wheel overlay of claim 6, wherein the center cap includes at least one ornamental feature.

8. The vehicle wheel overlay of claim 6, wherein the center cap includes a locking mechanism to impede removal of the vehicle wheel overlay.

9. A vehicle wheel overlay attachment system comprising:
a vehicle wheel including a plurality of recesses into which a lug nut is inserted;
a vehicle wheel overlay including:
a body having a shape corresponding to a shape of a vehicle wheel;
a plurality of lug nut engaging areas corresponding to each lug nut of the vehicle wheel; and
an extension corresponding to each lug nut engaging area that is configured to engage a portion of the lug nut.

10. The vehicle wheel overlay attachment system of claim 9, wherein each extension is made of a material selected from the group consisting of: plastic polycarbonate, metal, and acrylic.

11. The vehicle wheel overlay attachment system of claim 9, wherein each extension includes at least one lip for engaging with and disengaging from a corresponding lug nut.

12. The vehicle wheel overlay attachment system of claim 11, wherein the shape of the lip for engaging with and disengaging from a corresponding lug nut is selected from the group consisting of: rounded, angled and wedge-shaped.

13. A vehicle wheel overlay attachment system comprising:
a lug nut; and
a vehicle wheel overlay including:
a body of the vehicle wheel overlay having a shape corresponding to a shape of the vehicle wheel;
a plurality of lug nut engaging areas, at least one of the lug nut engaging area including at least one extension configured to engage a portion of the lug nut after the lug nut has been tightened.

14. The vehicle wheel overlay attachment system of claim 13, wherein each extension includes at least one lip for engaging with and disengaging from the lug nut.

15. The vehicle wheel overlay attachment system of claim 14, wherein the vehicle wheel overlay includes at least one additional mechanism for affixing the vehicle wheel overlay to the wheel.

16. The vehicle wheel overlay attachment system of claim 15, wherein the additional mechanism for affixing the vehicle wheel overlay to the wheel is selected from the group consisting of: an adhesive strip, a magnet, a screw, a rivet, a bolt, and a clip engaging a portion of the wheel.

17. The vehicle wheel overlay attachment system of claim 14, wherein the body includes a center portion having an opening, and wherein a center cap is insertable into the center portion.

18. The vehicle wheel overlay of claim 17, wherein the center cap includes a locking mechanism to impede removal of the vehicle wheel overlay.

19. The vehicle wheel overlay attachment system of claim 17, wherein the center cap has an outer flange with holes through which the lug nuts extend;
at least one threaded lug nut cover; and
the center cap is affixed by the threaded lug nut cover.

20. The vehicle wheel overlay attachment system of claim 19, wherein the center cap acts as an additional attachment mechanism for the wheel overlay.
